(19) United States
(12) Patent Application Publication
(10) Pub. No.: US 2008/0022247 A1
(43) Pub. Date: Jan. 24, 2008

(54) Layout method and semiconductor device

(76) Inventors: Tomokazu Kojima, Osaka (JP); Munehiko Ogawa, Osaka (JP)

Correspondence Address: MCDERMOTT WILL & EMERY LLP, 600 13TH STREET, NW, WASHINGTON, DC, 20005-3096, US

(21) Appl. No.: 11/812,416

(22) Filed: Jun. 19, 2007

(30) Foreign Application Priority Data
Jun. 23, 2006 (JP) 2006-173478

(51) Int. Cl. G06F 17/50

(52) U.S. Cl. 716/8

(57) ABSTRACT

The present invention is provided with a plural cell including a transistor pair. The plural cells are arranged at equal intervals so as to configure a cell group. A inter-cell distance between a transistor in one of the cell and a transistor the other cell in each of adjacent cells in the cell group is equal to a intra-cell distance between one of the transistor and the other transistor in the transistor pair.

### BACKGROUND OF THE INVENTION

1. Field of the Invention

The present invention relates to a semiconductor device provided with a plural cell including a transistor pair and having a plural output terminal and a layout method of a circuit element. In particular, the present invention relates to a liquid crystal display driver.

2. Description of Related Art

Conventionally, as shown in a Japanese publication patent document (Japanese Patent Application Laid-open No. 2006-101108) and a Japanese patent document (Japanese patent No. 3179424), in the semiconductor device that has a plural cell of the same specification wherein the relative configuration accuracy is requested between adjacent cells, the technique for improving an output characteristic of a plural terminal by taking matching of an element is known.

For example, as for a semiconductor device that configures a liquid crystal driver, each cell is configured with an operational amplifier. An irregular luminance and an irregular color etc. of picture data are reduced and a high picture quality is obtained by equalizing an offset voltage and a slew rate between the plural operational amplifiers.

An example of a configuration of a conventional semiconductor device A5 is shown in FIG. 5. In FIG. 5, reference numeral Q is a transistor, and reference numerals S, G, and D are a source, a gate, a drain of the transistor respectively, and reference numeral Q′ is a dummy element. In the prior art, relative configuration accuracy is secured by arranging the transistor so as to turn around to an edging deviance and a mask deviance.

Cells C₁ to Cₙ are operational amplifiers, and provide a differential amplifier circuit and a current mirror circuit. The transistors that configure them make a pair consisting of two respectively (hereafter, it is called “transistor pair”), and these transistor pairs are arranged in parallel at equal intervals. In this configuration, the relative configuration accuracy of both transistors that configure the transistor pair decides the characteristic. By equalizing an electrode layer and an electric contact (equal length and equal material of the metal) in addition to taking a symmetric arrangement of this both transistors, the characteristic of the transistor pair is equalized symmetrically. The differential amplifier circuit and the current mirror circuit of each cell are given symmetric property where the center of the element is made to be a starting point by adding the dummy element Q′ to both ends. As a result, the characteristic mutually becomes equal between adjacent cells in C₁ to Cₙ.

In general, variation based on the fabrication of the semiconductor device is known to consist of a local variation and a whole situation variation. The local variation is an irregular element that corresponds to a white noising of the process variation. The whole situation variation is a variation element due to the temperature gradient etc. at fabrication, and a smooth shift is shown over an entire wafer.

As measures of the local variation of the transistor, it pays attention to the phenomenon that “Variation of the threshold voltage is proportional to the reciprocal of the square of product L and W of the transistor sizing” (hereafter, it is called “reciprocal proportionality relation”), and the channel length L and channel width Win the transistor are decided so that the local variation of the transistor should not occur.

As measures against the whole situation variation, as shown in the non-patent document (J. Bastors, M. Steyert, B. Graindourze, W. Sansen, “Matching of MOS Transistors with Different Layout Styles”, IEEE International Conference on Microelectronics Test Structures, Vol. 9, pp. 17-18, March 1996), there is a method employing the layout of the transistor pair with point symmetry such as a common centroid type and a waffle type with the network arrangement. According to this, since the relative configuration accuracy of the transistor pair is improved, the influence of the whole situation variation is minimized.

Conventionally, the relative configuration accuracy of the differential amplifier circuit and the current mirror circuit is improved and the characteristic of the cell unit is secured, by using such a method. And then, the semiconductor device that aligns the plural cells achieves to make the output characteristic of a plural terminal uniform.

In the above-mentioned semiconductor device A5, since it concentrates on the improved property of the cell unit, in the case where the voltage of each output terminal is 5V, it varies between adjacent cells like 5V from cell C₁, 5.02V from cell C₂ and 4.98V from cell C₃ when it comes under the influence of the process variation. Moreover, this variation occurs irregularly. This is because the density and the distance of the polysilicon are different in the layout arrangement, and because the factor of the whole situation variation is complex and large.

Then, each cell is designed and arranged on the basis of the knowledge mentioned above after each parameter such as variation of the transistor is investigated according to the characteristic of the cell. In this case, the cell size is difficult to calculate accurately except for a termination phase of the circuit design. Additionally, there is a possibility of causing the degradation of the relative configuration accuracy when the distance between transistors is adjusted for reduction of area. With respect to the relative configuration accuracy between the adjacent cells, for example, between the cell C₁ and the cell C₂, between the cell C₂ and the cell C₃ and the like, it is difficult to avoid the influence of the process variation.

Consequently, it is considered that distance d₁′ between the transistor dummy elements and distance d₃ between dummy elements of the adjacent cell is made equal to distance d₁ between transistors. However, the influence of the effect of the loading is different according to distance d₃ between dummy elements and size d₄ of the dummy element, and the variation is not still eliminated. When distance d₃ between dummy elements is enlarged, the influence of the whole situation variation also grows, and, as a result, the characteristic of the cell will vary.

On the other hand, it is also considered that two dummy elements of the adjacent cell are shared as distance d₃=0 between dummy elements. However, the influence of the whole situation variation is still received only to the area of the dummy element.

Moreover, in the case where the size of the dummy element is made identical with the size of the transistor, the accuracy improvement can be expected. However, the occupation area of the dummy element grows, and then the area requires about twice the necessary area of an original transistor. In this case, the distance between cell C₁and cell Cₙ becomes two times, and then the relative configuration accuracy variation expands. This means that it is influenced much more as the numbers of cells is more. Moreover, the cost rise of the semiconductor device is brought due to growth of the size.

### SUMMARY OF THE INVENTION

Therefore, the main aim of the present invention is to provide a semiconductor device that can achieve uniformity of the output characteristic of a plural terminal without generating growth of the area enhancement and complexity of the circuit in the semiconductor device consisting of the plural cell, and a layout method of a circuit element.

In order to solve the subject mentioned above, a semiconductor device according to the present invention including

a plural cell including at least a transistor pair,

wherein

the plural cells are arranged at equal intervals so as to configure a cell group, and

an inter-cell distance between a transistor in one of the cell and the other transistor in the cell in each of adjacent cells in the cell group is equal to an intra-cell distance between one of the transistor and the other transistor in the transistor pair.

In this configuration, since the inter-cell distance is equalized to the intra-cell distance after the plural cells are aligned at equal intervals, the whole situation variation is made constant, and uniformity of the output characteristic of plural terminals is achieved even if the dummy element is not inserted into an individual cell.

In the above-mentioned configuration, there is an embodiment that a dummy transistor is further provided outside of a cell array direction of an end cell located at both ends of the cell group, and the aforementioned dummy transistor is arranged at the intra-cell distance from the transistor pair in the end cell.

Moreover, in the above-mentioned configuration, there is an embodiment that a dummy cell with the same specification as the cell is further provided outside of a cell array direction of an end cell located at both ends of the cell group, and a transistor constituting the aforementioned dummy cell is arranged at the intra-cell distance from the transistor pair in the end cell.

In these embodiments, since the dummy transistor or the dummy cell is arranged, the relative configuration accuracy can be further improved. Moreover, since the dummy transistor or the dummy cell is arranged only at both ends of the cell group and the dummy element is not provided in an individual cell, an area increase is controlled.

Moreover, in the above-mentioned configuration, there is an embodiment that the intra-cell distance is equal to the channel length or the channel width of a transistor in the transistor pair. According to this, an effect described below is further obtained.

That is, a variation of the threshold voltage of the transistor is approximated to the value proportional to the reciprocal of the square of the product of transistor size W and L (Above-mentioned reciprocal proportionality relation). Then, in this embodiment, by fixing the length of the channel or the channel width within the variation range of the allowed threshold voltage, and setting up the distance between transistors to become equal to this, the improvement of the characteristic and the optimization of the cell size are simply achieved.

Moreover, in the above-mentioned configuration, there is an embodiment that, assuming that the total length of the cell group is be x, the number of said cells that configure the cell group is n, the number of the transistor pairs that configure the cell is m, the intra-cell distance and the inter-cell distance is d1, and the size in the x direction of the total length of the transistor is L, a relation of

x=2·n·m(L+d₁) (1)

is satisfied.

A layout method of a circuit element according to the present invention is a layout method of a circuit element in a semiconductor device that is equipped with a plural cell including at least a transistor pair, the layout method including:

aligning the plural cells at equal intervals to constitute a cell group;

setting up the inter-cell distance between a transistor in one of the cell and a transistor in the other cell in each of adjacent cells in the cell group so as to be equal to the intra-cell distance between one of the transistor and the other transistor in the transistor pair; and then

laying out a configuration of the cell under the condition that satisfies a relation of

x=2·n·m(L+d₁), (2)

assuming that the total length of the cell group is x, the number of said cells that configure the cell group is n, the number of the transistor pairs that configure the cell is m, the clearance in the cell and the inter-cell distance is d1, and the size in the x direction of the total length of the transistor is L.

In the cell group constituted based on the conditions described above, the variation is small in the process variation and furthermore the size of the cell group is small. Moreover, since the dummy element is unnecessary for each cell, an area increase is controlled while improving the relative configuration accuracy.

According to the present invention, after aligning the plural cells at equal intervals, the inter-cell distance is equalized to the intra-cell distance. Therefore, the whole situation variation can be made constant, and the output characteristic of plural terminals can be made uniform without generating increase of the area and complexity of the circuit instead of insertion of the dummy element in an individual cell.

When the present invention is especially applied to a liquid crystal driver, an output characteristic homogeneity will contribute largely to the improvement of the picture quality, and it can strike a balance between the improved property and reduction of costs. A liquid crystal display that mounts this liquid crystal driver is the one with a small area (narrow frame) and a low-cost.

According to the semiconductor device of the present invention, uniformity of the output characteristic of plural terminals can be achieved without generating increase of the area and complexity of the circuit in the semiconductor device. In particular, it is useful for semiconductor devices such as a liquid crystal display driver and an organic EL display driver, etc.

### BRIEF DESCRIPTION OF THE DRAWINGS

If the embodiments described below are understood, the objects other than this of the present invention becomes clear, and they will be clearly shown in the attached claims. And, if this invention is implemented, those skilled in the art will appreciate a lot of benefits that are not recited in this specification.

FIG. 1 is a plan view showing a schematic configuration of a semiconductor device according to a first embodiment of the present invention;

FIG. 2 is a plan view showing a schematic configuration of a semiconductor device (with a dummy transistor) according to a second embodiment of the present invention;

FIG. 3 is a plan view showing a schematic configuration of a semiconductor device (with a dummy cell) according to a third embodiment of the present invention;

FIG. 4 is a plan view showing a schematic configuration of a semiconductor device according to a fourth embodiment of the present invention;

FIG. 5 is a plan view showing a schematic configuration of a semiconductor device according to the conventional technology.

### DETAILED DESCRIPTION OF THE INVENTION

Hereafter, the embodiments of a semiconductor device and a layout method of a circuit element according to the present invention is explained in detail on the basis of the drawings.

### First Embodiment

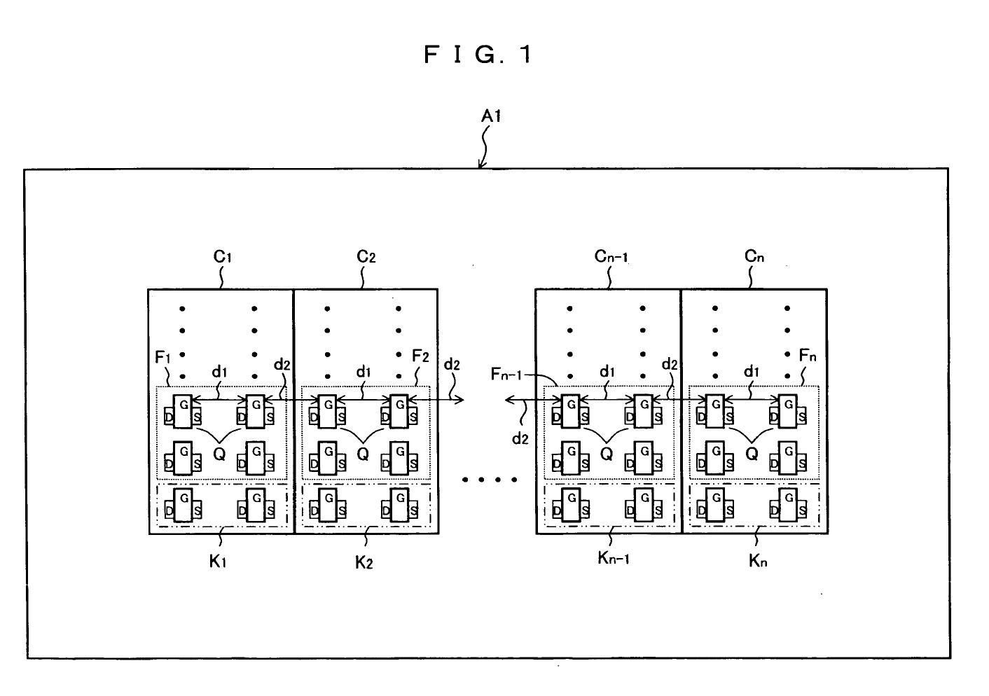

FIG. 1 is a plan view showing a schematic configuration of a semiconductor device A1 according to the first embodiment of the present invention. In FIG. 1, reference numerals C₁ to Cₙ (where n is a natural number of two or more) are cells with the same specification in each other, and reference numerals F₁ to Fₙ are differential amplifier circuits constituting the cell, and reference numerals K₁ to Kₙ are current mirror circuits constituting the cell. Both of the differential amplifier circuit and the current mirror circuit are configured from a transistor pair consisting of a couple of transistor. Reference numeral d₁ is a distance between one of transistor and the other of transistor in the transistor pair (It is strictly distance from the gate edge to the gate edge, and, hereafter, it is called “intra-cell distance”).

The plural cell C₁ to Cₙ is aligned at equal intervals so as to constitute the cell group, a distance (hereafter, it is called “inter-cell distance”) d₂ between a transistor in one of the cell and a transistor in the other cell in adjacent cells in the cell group is equal to the intra-cell distance d₁ (d₁=d₂).

The circuit constituted with the transistor pair that similarly requires the relative configuration accuracy other than the differential amplifier circuit and the current mirror circuit must be arranged similarly. In addition, the common centroid type of arrangement and the waffle type of arrangement may be set up in each cell of the differential amplifier circuit and the current mirror circuit.

Moreover, it may execute expansion and contraction in the direction of height according to the number of transistor without changing the width of the cell with respect to the transistor that does not require the relative configuration accuracy other than the differential amplifier circuit and the current mirror circuit. In this case, the limitation is not given especially to an equal distance of the transistor, a direction and an arrangement of the transistor, it may be arranged so as to reduce the area.

A signal input into each of the cells C₁ to Cₙ is processed with the differential amplification circuit F₁ to Fₙ and the current mirror circuit K₁ to Kₙ respectively, and the signal is output as n pieces of signals. At this time, for example, as for the liquid crystal driver, it is expected that the level of the output signal is also equal when the level of the input signal is equal. It is preferable that not only the output voltage but also the rising time and falling time of the signal, the distortion of the waveform, slew rate, and phase margin, etc. are equal.

According to this embodiment, since the inter-cell distance d₂ equates to the intra-cell distance d₁ (d₁=d₂), uniformity of the output characteristic of plural terminals can be achieved without generating increase of the area and complexity of the circuit.

In an equipment of producing semiconductor, when plural MOS transistors are fabricated by the same size, it is known to be as follows:

Aαₒᵢ=Aα₀+(dα₀/dx)˜xᵢ+(dα₀/dy)·yᵢ (3)

Aβᵢ=Aβ+(dβ/dx)·xᵢ+(dβ/dy)·yᵢ (4)

Here, it sets up the starting point on the chip, and the characteristic of the MOS transistor at the starting point is assumed to be Aα₀ (threshold voltage) and Aβ. Moreover, the whole situation variation of the transistor is assumed to be (dα₀/dx,dα₀/dy,dβ/dx,dβ/dy), and this is assumed that it has an one-dimensional inclination. Center coordinates of the noted transistor are assumed to be xᵢ and yᵢ, and the mean property (Aαₒᵢ, Aβᵢ) is given by the above-mentioned model equations (3) and (4). “A” means an average.

Under such a condition, the whole situation variation is made constant by equalizing the inter-cell distance d₂ to the intra-cell distance d₁. As a result, the whole situation variation is further possible to be controlled drastically compared with the example in the prior art where the dummy element are inserted.

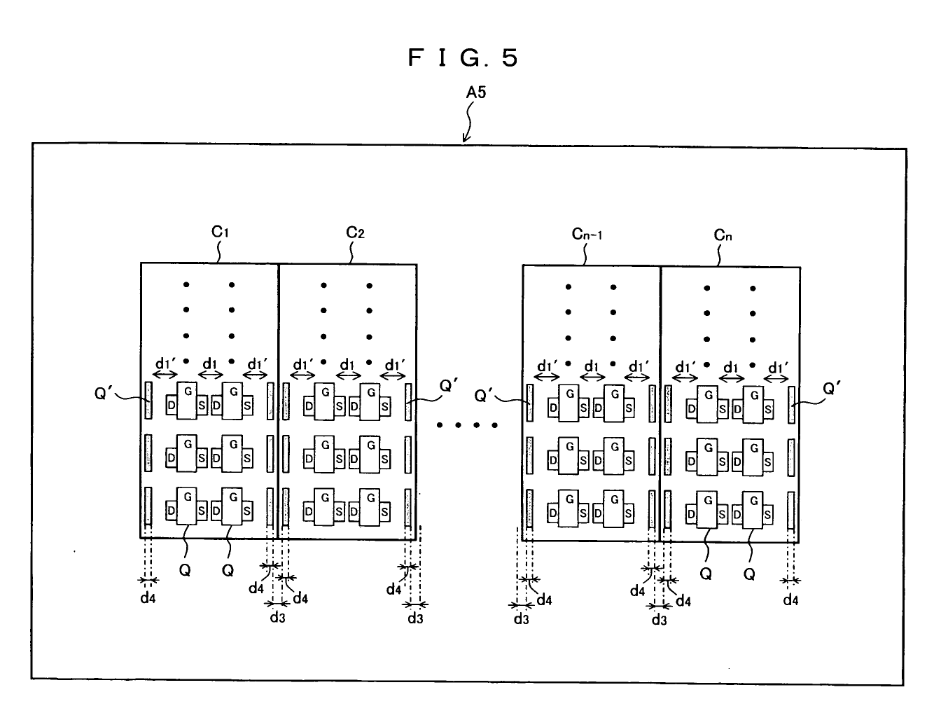

In the case of the conventional technology shown in FIG. 5 wherein it is focused on the improvement of property in the cell unit, the output characteristic between adjacent cells varies irregularly like 5V from cell C₁, 5.02V from cell C₂, and 4.98V from cell C₃, when the influence of the process variation is received.

On the other hand, in the configuration of this embodiment shown in FIG. 1, since distribution and density of polysilicon in the entire cell group are equal and it is arranged at equal intervals, the whole situation variation becomes a linear approximation (Change into linear even if it changes). That is, when the voltage of each output terminal is adjusted to 5V, since the whole situation variation is made constant in this manner as 4.98V from cell C₁, 5.0V from cell C₂, and 5.02V from cell C₃, variation of output characteristic between adjacent cells can be reduced dramatically. Furthermore, uniformity of the output characteristic in plural terminals can be achieved without generating increase of the area and complexity of the circuit. When the technique of this embodiment is applied to the liquid crystal driver, the improvement of the picture quality can be attempted.

### Second Embodiment

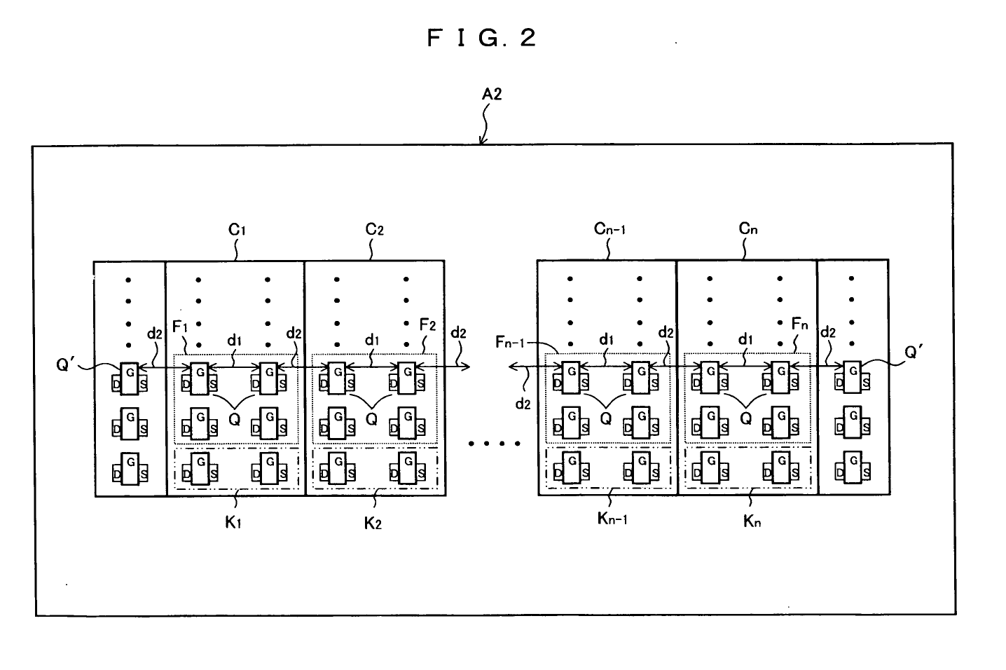

FIG. 2 is a plan view showing a schematic configuration of a semiconductor device A2 according to the second embodiment of the present invention. The same reference numeral in FIG. 1 of the first embodiment indicates the same component in FIG. 2. In this embodiment, a dummy transistor Q′ is arranged outside of the cell array direction of cells C₁ and Cₙ in both ends of the cell group respectively, in addition to configuration of FIG. 1. The dummy transistor Q′ is arranged at a position separated by the intra-cell distance d₁ from transistor Q of group end cell C₁ and Cₙ located on the edge of the cell group. That is, the inter-cell distance d₂ is equalized also here to the intra-cell distance d₁ (d₁=d₂). The explanation is omitted about the other configuration since it is similar to the first embodiment.

According to this embodiment, since the distribution density of the transistor becomes uniform over the total length of the cell group, the relative configuration accuracy of the cell can be furthermore improved. Since the dummy transistor Q′ is arranged only at both ends of the cell group, and it is not provided in individual cells C₁ to Cₙ an area increase is controlled.

### Third Embodiment

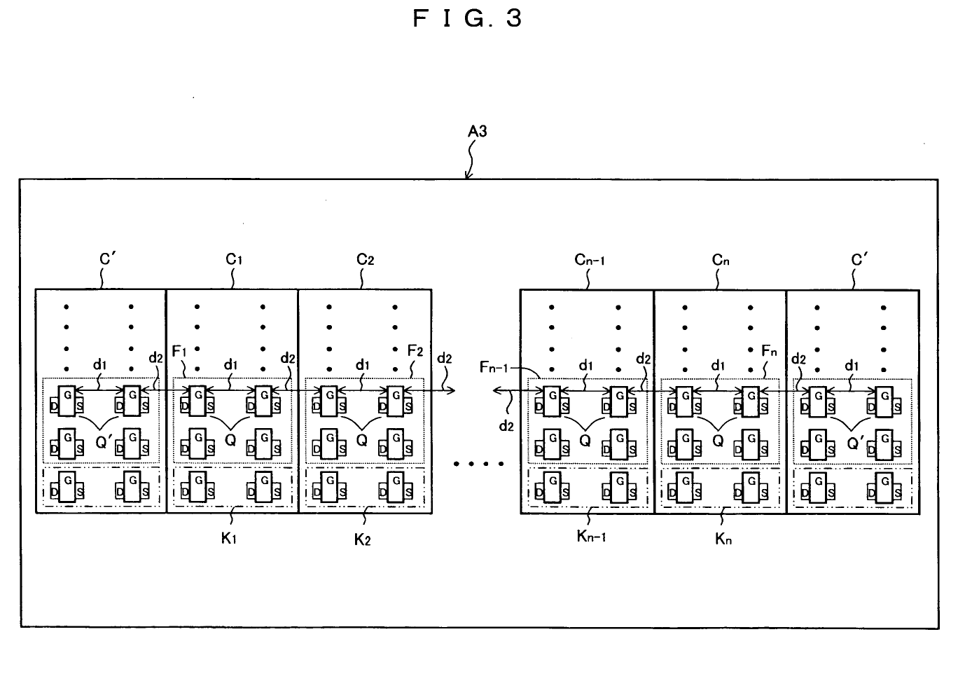

FIG. 3 is a plan view showing a schematic configuration of a semiconductor device A3 according to the third embodiment of the present invention. The same reference numeral in FIG. 1 of the first embodiment indicates the same component in FIG. 3. In this embodiment, a dummy cell C′ is arranged outside of the cell array direction of cells C₁ and Cₙ located on the edge of the cell group (both ends) respectively, in addition to the configuration of FIG. 1. The dummy cell C′ has the size and the element interval with the same specifications in each cell. The inner transistor in the dummy cell C′ is arranged at a position separated by the intra-cell distance from the transistor Q of each cell C₁ and Cₙ located on the edge of the cell group. That is, the inter-cell distance d₂ is equalized also here to the intra-cell distance d₁ (d₁=d₂). The explanation is omitted about the other configuration since it is similar to the first embodiment.

According to this embodiment, since the distribution density of the transistor and the cell becomes uniform over the total length of the cell group, the relative configuration accuracy of the cell is furthermore improved. Since the dummy cell C′ is arranged only at both ends of the cell group, and it is not provided in individual cell C₁ to Cₙ, an area increase is controlled.

### Fourth Embodiment

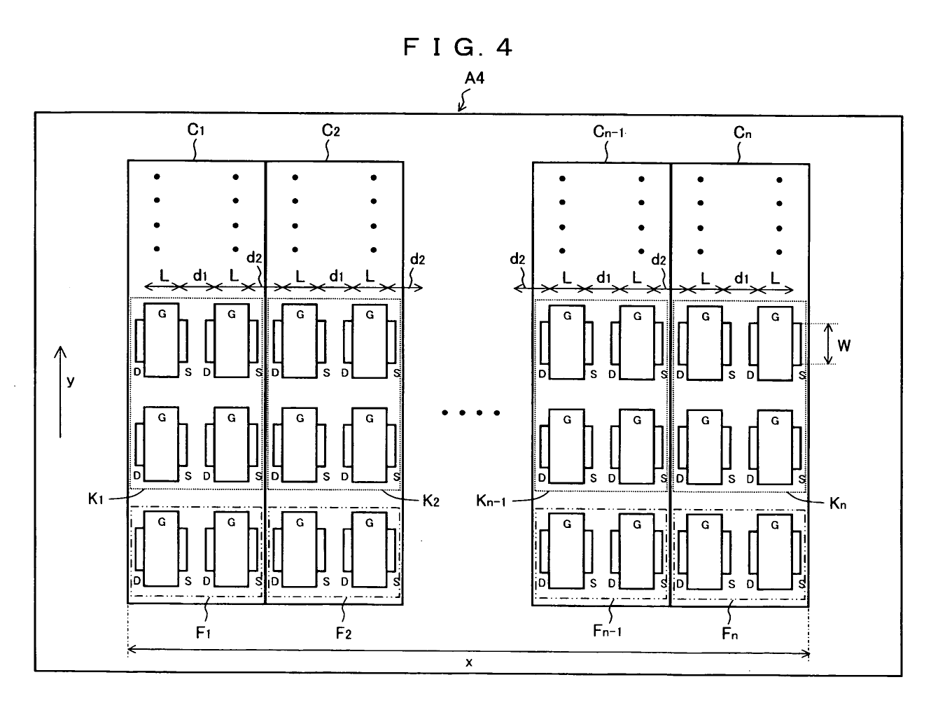

FIG. 4 is a plan view showing a schematic configuration of a semiconductor device A4 according to the fourth embodiment of the present invention. The same reference numeral in FIG. 1 of the first embodiment indicates the same component in FIG. 4. In this embodiment, the channel length L that is the transistor size is configured so as to be equal to the intra-cell distance d₁.

Assuming that the total length of the cell group is x, the number of cells that configure the cell group is n, the number of transistor pairs that configure the cell is m (since the transistor pair is one pair in the illustrative example, m=1), the intra-cell distance and the inter-cell distance is d₁=d₂, and the size in the direction of the transistor of total length x is L, the following relation is satisfied:

x=2˜n·m(L+d₁) (5)

Hereinafter, a layout method of the circuit element of the semiconductor device A4 is explained.

1) The allowed transistor size L and W according to the above-mentioned reciprocal proportionality relation are selected from the variation data of the threshold voltage (here, L is length of the channel, and W is channel width).

2) The transistor pair is set to be same transistor size L and w, and, in addition, the intra-cell distance d₁ is equalized to the length L of the channel (d₁=L). Here, when the intra-cell distance d1 is equal to the channel length L, it is included in the range of minimum processing accuracy ΔL of the transistor.

|d1|<=L±ΔL (6)

3) The inter-cell distance d₂ is also equalized to the length L of the channel (d₂=d₁). The illustrative example corresponds to m=1, and becomes x=2·n(L+d₁).

The size x of the cell group can be decided from the variation data of the transistor before the circuit design of the cell is completed according to the procedure of 1) to 3) mentioned above. In the cell group configured like this, the variation is small in the process variation and the size of the cell group is a small.

In this embodiment, the efficiency of the processing for the property improvement and the area minimization is enhanced because it only selects transistor size L and W allowed in the cell according to the above-mentioned reciprocal proportionality relation from the variation data of the threshold voltage, compared with the conventional technology wherein it is difficult to obtain the cell size accurately except for a termination phase of the circuit design since it accompanies the investigation of each parameter matched to the characteristic. Moreover, since the dummy element is unnecessary for each cell, an area increase is controlled while improving the relative configuration accuracy.

When the procedure of this embodiment is executed in the liquid crystal driver, and the standard related to the homogeneity of the cell is decided, the cell size and the size of the liquid crystal driver can be decided even in the case without using the circuit design step and the layout design step. As just described, this embodiment can decide the cell size promptly and accurately since it does not depend on the circuit design step and the layout design step like this. In addition, since the homogeneity of the cell group can be enhanced and the area of the liquid crystal driver can be reduced, not only the improvement of property and reduction in costs but also the development times can be shortened. Moreover, since it may take only the processing for deciding the transistor size L or W, the step after that can be implemented without manpower. Uniformity of the output characteristic of plural terminals can be achieved without generating increase of the area and complexity of the circuit according to this embodiment like this.

In addition, although it is described above with respect to the x direction, it is needless to say that it can be applicable also to the y direction. Moreover, the relative configuration accuracy can be further improved by applying to both direction of x and y. In addition, although the MOS transistor was explained for which embodiment in the above-mentioned, it is needless to say to be able to configure a similar circuit by using a bipolar transistor, a resistance, a condenser, and a coil. Additionally, the present invention can be modified and changed freely within the range of the purpose of the present invention without being limited to the above-mentioned embodiments.

Although the most preferable concrete example about this invention was explained in detail, the combination and the alignment of parts of the preferred embodiment can be changed variously without running contrary to the spirit and the range of this invention later claimed.

What is claimed is:

1. A semiconductor device comprising
a plural cell including at least a transistor pair, wherein
the plural cells are arranged at equal intervals so as to configure a cell group, and
an inter-cell distance between a transistor in one of the cell and a transistor in the other cell in each of adjacent cells in the cell group is equal to an intra-cell distance between one of the transistor and the other transistor in the transistor pair.

2. The semiconductor device according to claim 1 wherein
a dummy transistor is further provided outside of a cell array direction of a group end cell located at both ends of the cell group, and the aforementioned dummy transistor is arranged separating by the intra-cell distance from the transistor pair in the group end cell.

3. The semiconductor device according to claim 1 wherein
a dummy cell with the same specification as the cell is further provided outside of a cell array direction of a group end cell located at both ends of the cell group, and a transistor that configures the aforementioned dummy cell is arranged separating by the intra-cell distance from the transistor pair in the group end cell.

4. The semiconductor device according to claim 1 wherein
the intra-cell distance is equal to the channel length or the channel width of a transistor in the transistor pair.

5. The semiconductor device according to claim 1 wherein
assuming that the total length of the cell group is x, the number of said cells that configure the cell group is n, the number of the transistor pairs that configure the cell is m, the intra-cell distance and the inter-cell distance is d1, and the size in the direction of the total length x of the transistor is L,
a relation of x=2·n·m(L+d₁) is satisfied.

6. A layout method of a circuit element in a semiconductor device provided with a plural cell including at least a transistor pair, the layout method comprising:
aligning the plural cells at equal intervals so as to make up a cell group;
setting up the inter-cell distance between a transistor one of the cell and a transistor of the other cell in each of adjacent cells in the cell group to be equal to the intra-cell distance between one of the transistor and the other e transistor in the transistor pair; and then
laying out a configuration of the cell under the condition that satisfies a relation of x=2·n·m(L+d₁), assuming that the total length of the cell group is x, the number of said cells that configure the cell group is n, the number of the transistor pairs that configure the cell is m, the intra-cell distance and the inter-cell distance is d1, and the size in the direction of the total length x of the transistor is L.
